(19) United States
(12) Patent Application Publication
(10) Pub. No.: US 2010/0088196 A1
(43) Pub. Date: Apr. 8, 2010

(54) Methods for Designing, Pricing, and Scheduling Well Services and Data Processing Systems Therefor

(76) Inventors: Michael J.R. Segura, Duncan, OK (US); Craig W. Roddy, Duncan, OK (US); Ronney R. Koch, Duncan, OK (US); Rickey L. Morgan, Duncan, OK (US); Ronnie G. Morgan, Waurika, OK (US); Ricki G. Ingalls, Stillwater, OK (US); William J. Giffen, Wheat Ridge, CO (US); William J. Caveny, Rush Springs, OK (US)

Correspondence Address: ROBERT A. KENT, P.O. BOX 1431, DUNCAN, OK, 73536, US

(21) Appl. No.: 12/629,687

(22) Filed: Dec. 2, 2009

Related U.S. Application Data
(63) Continuation-in-part of application No. 10/929,285, filed on Aug. 30, 2004, now Pat. No. 7,636,671.
Application No. 10/929,285 is a continuation of application No. 11/363,684, filed on Feb. 28, 2006, now abandoned.

(51) Int. Cl. G06Q 10/00; G06Q 50/00; G06Q 30/00

(52) U.S. Cl. 705/27; 705/400; 705/301

(57) ABSTRACT

Methods comprising for pricing and scheduling one or more well services comprising obtaining input data for the one or more well services, determining the well service specifications, determining a schedule for the one or more well services, determining costs for the one or more well services, and determining the price of the one or more well services based on a plurality of factors, wherein the plurality of factors comprises the schedule and the costs. Methods comprising for pricing and scheduling one or more well services comprising obtaining input data for the one or more well services, the input data comprising well characteristics of the one or more well service, determining a schedule for the one or more well services, determining the price of the one or more well service based on a plurality of factors, wherein the plurality of factors comprises the schedule and the well characteristics.

### CROSS-REFERENCE TO RELATED APPLICATIONS

This application is a continuation-in-part of co-pending U.S. patent application Ser. No. 10/929,285 filed Aug. 30, 2004, and a continuation of U.S. patent application Ser. No. 11/363,684, filed Feb. 28, 2006, which are hereby incorporated by reference.

### BACKGROUND

The present invention relates to designing, pricing, and/or scheduling well services. More particularly, the present invention relates to methodologies for designing, pricing, and/or scheduling well services and data processing systems therefor.

Generally, well services include a wide variety of subterranean operations that may be performed in oil, gas, geothermal, and/or water wells, such as drilling, completion, and workover operations. The drilling, completion, and workover operations may include, but are not limited to, drilling, fracturing, acidizing, logging, cementing, gravel packing, perforating, and conformance operations. Many of these well services are designed to enhance and/or facilitate the recovery of desirable fluids from a subterranean well.

Well service companies and the like, who provide well services, operate in a competitive environment, often involving competition from other companies providing the same or similar services. Consequently, well service companies desire to accurately and cost-effectively determine the design, price, and schedule for their respective well service to maintain their competitiveness. Typically, when a customer wants to purchase a well service from a well service company, that customer contacts that well service company and requests a quote for that particular well service. For example, a customer may request that a fracturing operation be performed on a particular well or set of wells. Once that request is made schedulers and cost estimators generally will formulate a price quote for the customer that includes a schedule for the well service. Thus, there is commonly a delay between when the customer request is made and when the price quote is provided. However, in recent years, there has been a trend to purchasing goods and services electronically, for example, using the Internet. Industries such as the airline industry have utilized online systems to allow their customers to purchase goods and services in real-time over the Internet.

### SUMMARY

The present invention relates to designing, pricing, and/or scheduling well services. More particularly, the present invention relates to methodologies for designing, pricing, and/or scheduling well services and data processing systems therefor.

One embodiment of the present invention is a method of pricing and scheduling one or more well services. Such a method may comprise obtaining input data for the one or more well services, determining the well service specifications, determining a schedule for the one or more well services, determining costs for the one or more well services, and determining the price of the one or more well services based on a plurality of factors, wherein the plurality of factors comprises the schedule and the costs.

Another embodiment of the present invention is a method of pricing and scheduling one or more well services. Such a method may comprise obtaining input data for the one or more well services, the input data comprising well characteristics of the one or more well service, determining a schedule for the one or more well services, determining the price of the one or more well service based on a plurality of factors, wherein the plurality of factors comprises the schedule and the well characteristics.

Another embodiment of the present invention is a system for pricing and scheduling one or more well services. Such a system may comprise a processor, and a memory communicatively coupled to the processor, the processor configured for obtaining input data for the one or more well services, determining a schedule for the one or more well services, determining costs for the one or more well services, and determining the price of the one or more well service based on a plurality of factors, wherein the plurality of factors comprises the schedule and the costs.

Another embodiment of the present invention is a system for pricing and scheduling one or more well services. Such a system may comprise a processor, and a memory communicatively coupled to the processor, the processor configured for obtaining well input data for the one or more well services, the well input data comprising well characteristics of the one or more well services, determining a schedule for the one or more well services, and determining the price of the one or more well services based on a plurality of factors, wherein the plurality of factors comprises the schedule and the well characteristics.

The features and advantages of the present invention will be apparent to those skilled in the art. While numerous changes may be made by those skilled in the art, such changes are within the spirit of the invention.

### BRIEF DESCRIPTION OF THE FIGURES

These figures illustrate certain aspects of some of the embodiments of the present invention, and should not be used to limit or define the invention.

FIG. 1 is a block diagram depicting a computer system for implementing the methods of the present invention in accordance with an embodiment of the present invention.

FIG. 2 is a block diagram depicting one implementation of a pricing and scheduling system in accordance with one embodiment of the present invention.

FIG. 3 is a flow chart for pricing and scheduling a well service in accordance with an embodiment of the present invention.

FIG. 4 is a flow chart for pricing and scheduling a well service in accordance with an embodiment of the present invention.

FIG. 5 is a flow chart for obtaining input data for a well service in accordance with an embodiment of the present invention.

### DESCRIPTION OF PREFERRED EMBODIMENTS

The present invention relates to designing, pricing, and/or scheduling well services. More particularly, the present invention relates to methodologies for designing, pricing, and/or scheduling well services and data processing systems therefor. The price of the well service may include pricing for chemicals, tools, labor, and/or equipment involved in the well service. While the methods of the present invention may be useful in a variety of applications, they may be particularly useful for a scheduling and pricing system that allows a user to electronically schedule a well service, for example, over the Internet. As used herein, the term “user” is defined to include real persons, data processing systems (e.g., computer systems, etc.), or any other suitable mechanism. The user may be associated with a provider of well services or be a customer of such well service company. In some embodiments, the user may an individual who is using a data processing system to schedule and price one or more well services.

The methods of the present invention may be used for designing, pricing, and scheduling a wide variety of well services that may be performed in oil, gas, geothermal, and/or water wells, such as drilling, completion, and workover operations. The drilling, completion, and workover operations may include, but are not limited to, drilling, fracturing, acidizing, logging, gravel packing, cementing, perforating, and conformance operations. The methods may be used for a particular well or a set of wells. In some embodiments, the methods may be used to determine a price for a particular set of well services that will be performed over a set period of time.

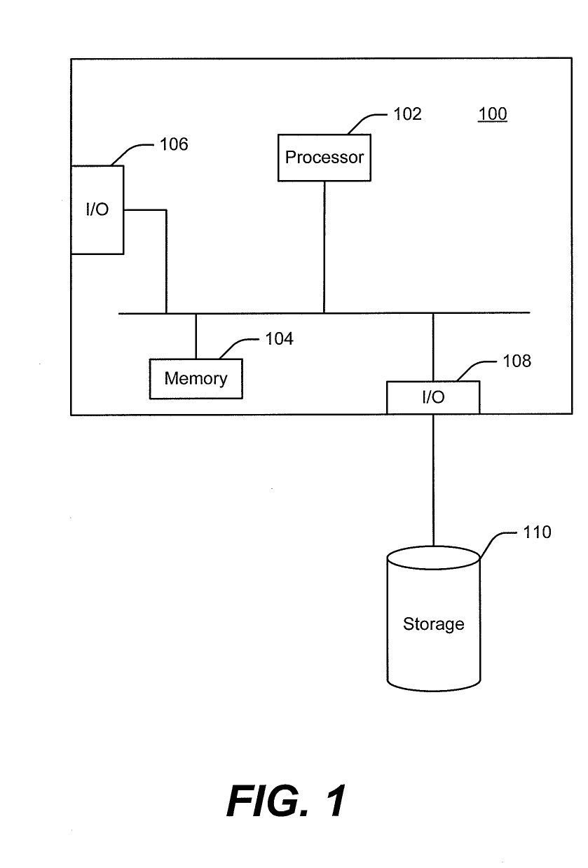

The methods of the present invention may be implemented utilizing any suitable data processing system, including computer systems, handheld devices, or any other suitable device. A suitable data processing system may include a processor, memory, and software operable on the processor to implement the methods of the present invention. FIG. 1 generally illustrates a computer system 100, one or more of which may be used to implement the methods of the present invention. Computer system 100 comprises processor 102, memory 104, input out (“I/O”) interface 106, and I/O interface 108. Processor 102 may comprise one central processing unit or may be distributed across one or more processors in one or more locations. Memory 104 should be communicatively coupled to processor 102. Memory 104 may be read-only memory, random-access memory, or the like. I/O interfaces 106 and I/O interfaces 108 should be communicatively coupled to processor 102. I/O interfaces 106 and I/O interfaces 108 may be any suitable system for connecting computer system 100 to a communication link, such as a direct connection, a private network, a virtual private network, a local area network, a wide area network (“WAN”), a wireless communication system, or combinations thereof; storage devices, such as storage 110; external devices, such as a keyboard, a monitor, a printer, a voice recognition device, or a mouse; or any other suitable system. Storage 110 also may be provided. Storage 110 should be communicatively coupled to I/O interfaces 108. Storage 110 may comprise any device suitable for storing data to be processed, including, but not limited to, compact disc drives, floppy drives, hard disks, and the like. Those of ordinary skill in the art will appreciate that suitable data processing systems may comprise additional, fewer, and/or different components than those described for computer system 100.

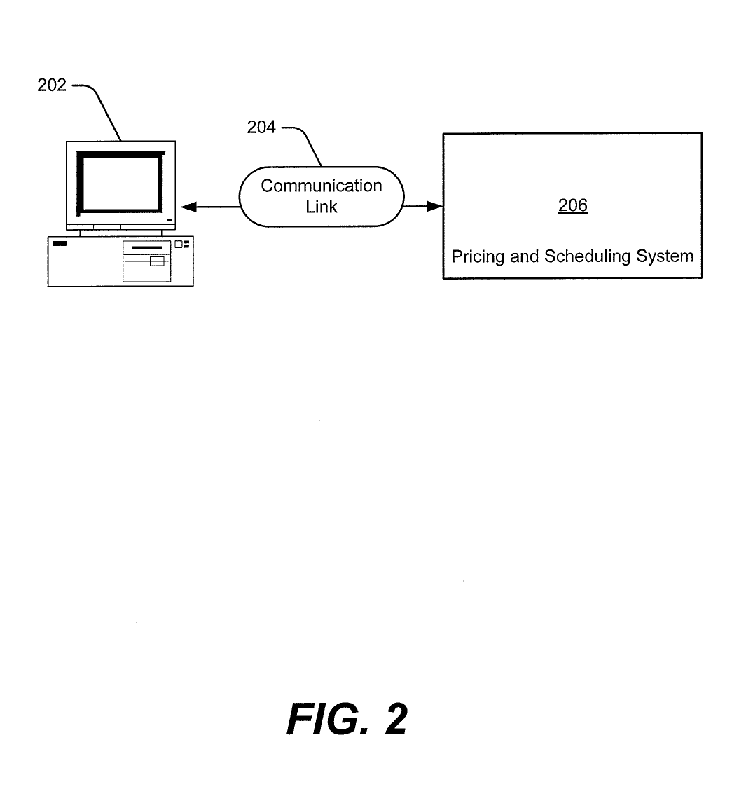

FIG. 2 is a depiction of system 200, in accordance with one embodiment of the present invention. System 200 may be implemented as software modules or components stored and executed on one or more data processing systems, such as computer system 100 illustrated in FIG. 1. In the embodiment illustrated in FIG. 2, system 200 generally comprises user computer system 202, communication link 204, and scheduling and pricing system 206.

User computer system 202 may include one or more data processing systems, such as those illustrated in FIG. 1. In some embodiments, user computer system 202 may be communicatively coupled to a wide area network (e.g., the Internet) via communication link 204. In some embodiments, user computer system 202 may be communicatively coupled to a local area network via communication link 204.

Communication link 204 may include a direct connection, a private network, a virtual private network, a local area network, a wide area network (e.g., an Internet-based communication system, a global positioning system, etc.), a wireless communication system (e.g., a satellite communication system, telephones), combinations thereof, or any other suitable communication link.

Scheduling and pricing system 206 may comprise one or more data processing devices, such as those illustrated in FIG. 1. Generally, the scheduling and pricing system 206 should be capable of determining a price and schedule for a well service based on input data obtained from a user. Such input data may include, but is not limited to, customer information, customer scheduling preferences, well characteristics, design specifications, and/or design objectives. In some embodiments, scheduling and pricing system 206 may be communicatively coupled to a wide area network (e.g., the Internet) via communication link 204. In one certain embodiment, scheduling and pricing system 206 may be used to allow users (e.g., customers) of user computer system 202, to schedule and price one or more well services. In some embodiments, scheduling and pricing system 206 may be communicatively coupled to a local area network via communication link 204.

Generally, scheduling and pricing system 206 may obtain data from and/or transmit data to user computer system 202 via communication link 206. In some embodiments, user computer system 202 may communicatively coupled to scheduling and pricing system 206 over communication link 204 via a wide area network (such as the Internet). In some embodiments, user computer system 202 may be communicatively coupled to scheduling and pricing system 206 via a local area network (such as an intranet). In some embodiments, scheduling and pricing system 206 may obtain data from, and transmit data to, a user of user computer system 202 via one or more screens on a website.

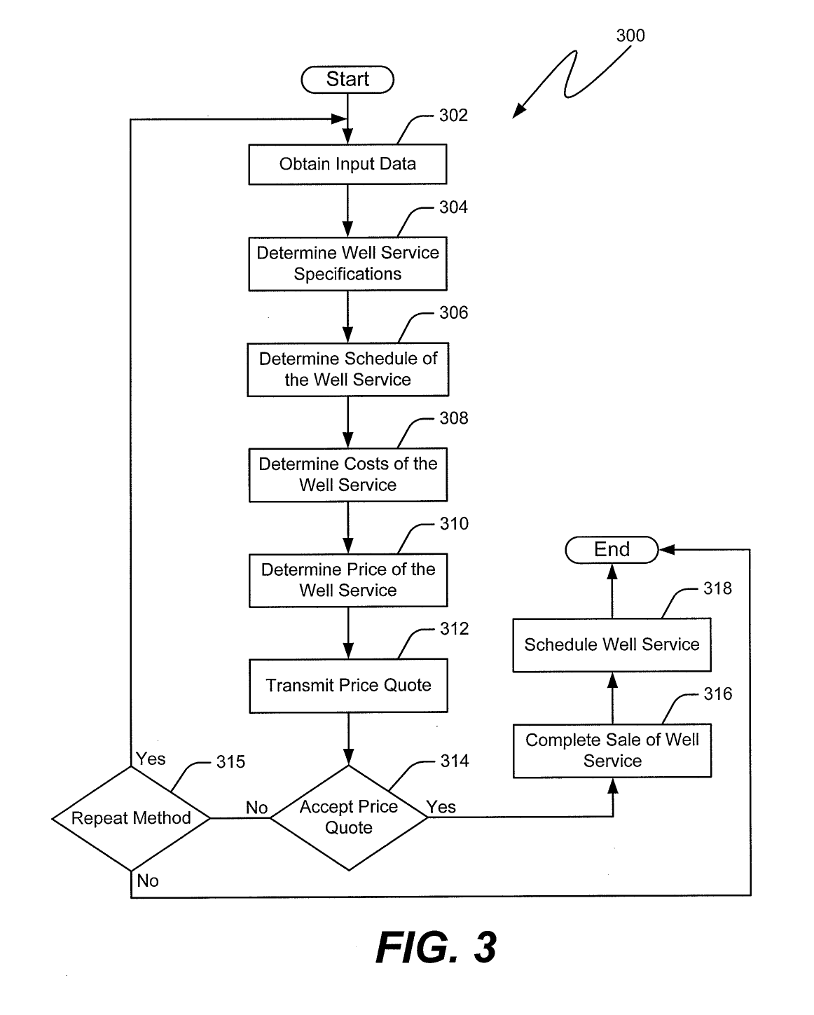

Referring to FIG. 3, a flow chart is illustrated that depicts an embodiment of a method of the present invention, generally referred to as method 300, that may be performed by scheduling and pricing system 206. In some embodiments, a data processing system (such as those illustrated in FIG. 1) may be used to implement this method. Method 300 generally involves determining a price and schedule for a well service in accordance with one embodiment of the present invention. Method 300 of the present invention generally may comprise: obtaining input data for the well service (block 302); determining the well service specifications (block 304); determining a schedule for the well service (block 306); determining costs for the well service (block 308); determining a price of the well service based on a plurality of factors (block 310) the plurality of factors comprising the schedule for the well service and the costs for the well service; and transmitting a price quote for the well service to a user (block 312), the price quote comprising the schedule and the price that were determined; determining whether the transmitted price quote is accepted (block 314); completing a sale of the well service (block 316); and scheduling the well service, if the sale is completed (block 318). Those of ordinary skill in the art will appreciate that certain of the above-listed steps may be optional, depending upon the particular application.

In block 302 of FIG. 3, input data for the well service is obtained. In some embodiments, the input data may be obtained using a data processing system, such as computer system 100 (depicted in FIG. 1). Input data may include, but is not limited to, customer information, customer scheduling preferences, well characteristics, design specifications, and design objectives. The input data may be obtained for a particular well or set of wells (e.g., wells in a particular field) dependent upon the particular well service. Where applicable, the input data may be obtained using a variety of techniques. In one embodiment, scheduling and pricing system 206 (depicted in FIG. 2) may obtain the input data from a user of user computer system 202 over communication link 204, for example, an Internet-based communication system. In some embodiments, computer system 100 may obtain data from, or transmit data to, a user thereof via suitable I/O means, such as a keyboard, a mouse, a voice recognition device, and/or a monitor that are communicatively coupled to computer system 100 via I/O interfaces. In these embodiments, processor 102 may execute scheduling and pricing system 206.

Customer information may be obtained as input data. Customer information may include a variety of different identifying information regarding the customer, including, but not limited to, the customer name, address, phone number, user ID, password, and combinations thereof.

Customer scheduling preferences also may be obtained as input data. In some embodiments, the user may specify whether flexible scheduling is allowed. In some embodiments, the user may want the well service to be scheduled on a particular date or dates. In other embodiments, the user may provide particular dates or a range of dates that are suitable.

Each well characteristic that may be obtained as input data may affect the well service specifications. The well characteristics include a variety of routinely measurable or calculable parameters inherent in or desirable for a well for a particular treatment, including, but not limited to, bottom-hole static temperature (“BHST”), bottom-hole circulating temperature (‘BHCT”), bottom hole treating pressures (“BHTP”), fracture gradient, closure pressure, Young's modulus, Poisson's ratio, depth, type of formation, type of hydrocarbons, formation porosity, formation permeability, existence of thief zone, corrosion potential, pipe friction, existence of reactive shale, and combinations thereof. The particular well characteristics used to generate the price of the well service will vary, dependent, inter alia, on the well service (e.g., drilling, completion, workover, etc.), the particular well or set of wells, and other factors known to those of ordinary skill in the art. Generally, any sensing technique and equipment suitable for detecting well characteristics with suitable sensitivity and/or resolution may be used to determine the well characteristics that are to be obtained. In some embodiments, the well characteristics may be determined using analytical methods, magnetic resonance imaging (“MRI”), formation evaluation, drill stem testing, logging tools, seismic methods, or other suitable techniques. For example, the well characteristics may be determined downhole with real-time data telemetry to the surface, or by delayed transfer (e.g., by storage of data downhole, followed by subsequent telemetry to the surface or subsequent retrieval of the downhole sensing device). In some embodiments, the well characteristics may be determined using any one or a combination of downhole logging-while-drilling sensors, measurement-while-drilling sensors, wireline and drillpipe-conveyed wireline tools, drillpipe-conveyed sensors, coiled tubing-conveyed sensors, casing-conveyed sensors, tractor-conveyed sensors, permanent downhole sensors, well production data sensors, fluid-conveyed sensors, or other suitable sensors.

Design specifications also may be obtained as input data. Design specifications may include any of a variety of specifications that may affect the determination of the well service specifications, including, but not limited to, applicable environmental regulations, geographical area, desired pump rate, desired pump time, pump schedule, desired density of treatment fluid, desired level of fluid loss control, desired pump time, transition time, displacement efficiencies, equivalent circulating densities, acceptable mud weight, proppant type, proppant quantities, and combinations thereof.

Design objectives also may be obtained as input data. Design objectives may include, but are not limited, maximization of conductivity, minimize cost, and combinations thereof.

In block 304 of FIG. 3, the well service specifications are determined. In some embodiments, the well service specifications may be determined by a data processing system, such as computer system 100 (depicted in FIG. 1) capable of determining the well service specifications of a well service. The well service specifications may be determined for a particular well or set of wells (e.g., wells in a particular field) dependent upon the particular well service. The well service specifications that may be determined include any of a variety of specifications that should be determined for pricing, scheduling, and performing a well service. Such well service specifications may include, but are not limited to, equipment, horsepower, fluid volumes, fluid rates, pressures, fluid formulations, chemical additives, tools, pump stages, backup resources, effective circulating densities, chemical concentrations, mud weight, proppant type, proppant quantity, man hours, and combinations thereof.

The well service specifications may be determined using any suitable methodology. For example, one or more well servicing specification may be determined utilizing suitable algorithms and/or well modeling software. Examples of suitable modeling software include FracproPT by Pinnacle Technologies, Inc., GOPHER by Barree and Associates, and OptiCem RT™ Cement Job Design and Simulation System by Halliburton Energy Services, Inc. Other modeling software also may be suitable. The well service specifications may be based a number of factors, including, but not limited to, well characteristics, design specifications, and/or design objectives. In some embodiments, one or more of the well service specifications may be provided by a user (e.g., a customer).

In block 306 of FIG. 3, a schedule for the well service is determined. In some embodiments, the schedule may be determined by a data processing system, such as computer system 100 (depicted in FIG. 1) capable of determining a schedule for the well service. Generally, an optimal schedule may be determined based on any of a variety of factors, including, but not limited to, the well service specifications, material and equipment requirements, customer preferences, equipment utilization targets, inventory, availability of resources, and other scheduled well services. For example, other scheduled services may be considered in determining the schedule. Regarding customer preferences, in some embodiments, the user may specify one or more dates for the well service. In some embodiments, the user may specify whether flexible scheduling is allowed. In some embodiments, the user may specify whether flexible scheduling is allowed. In some embodiments, the user may want the well service to be schedule a particular date or dates. In other embodiments, the user may provide particular dates or a range of dates that are suitable. The schedule also may be based on equipment utilization rates. Generally, well service companies prefer to maximize utilization rates of equipment so as to optimize the efficiency of equipment utilization. In some embodiments, more than one schedule for the well service may be determined. For example, more than one schedule may be determined where the user will be given the option of selecting a preferred price and schedule from a plurality of prices and schedules. The schedule may be determined using any of a variety of optimization algorithms, including, but not limited to, linear programming, integer programming, genetic algorithms, neural networks, simulation, simulated annealing and combinations thereof.

In block 308 of FIG. 3, the costs for the well service are determined. In some embodiments, the costs may be determined by a data processing system, such as computer system 100 (depicted in FIG. 1) capable of determining costs for the well service. Both fixed and variable costs may be determined. Fixed costs include, but are not limited to, equipment depreciation on rolling equipment, stationary equipment (such as bulk plant facilities), instruments and sensors, and the like. Variable costs include, but are not limited to, component costs of fluid(s) needed for the well service, fuel, labor, and the like.

In block 310 of FIG. 3, a price for the well service is determined. In some embodiments, the price may be determined by a data processing system, such as computer system 100 (depicted in FIG. 1) capable of determining a price of the well service treatment. The price of the well service may be determined using any suitable pricing methodology. The price of the well service should be based on the costs for the well service determined in block 308. The price of the well service should also be based on the schedule for the well service determined in block 306. Where the price of the well service is based on the schedule, the availability of resources also may be considered in determining the price. Where the price of the well service is based on the schedule, inventory also may be considered in determining the price. Where the price of the well service is based on the schedule, other scheduled services also may be considered in determining the price. Other factors that may be considered in determining the price include, but are not limited to, profit margin targets, the identity of the customer (e.g., pricing arrangements), and flexible scheduling discounts. Where a flexible scheduling discount is considered, a discount may be applied to the price if the customer allows flexible scheduling.

In some embodiments, determining the price of the well service may comprise correlating the price of the well service with the schedule. For example, the price for the well service may be correlated with the schedule so that a schedule is determined that corresponds to the lowest price for the well service.

In some embodiments, more than one price for the well service is determined. For example, where more than one schedule was determined, a price may be determined corresponding to each schedule. In these embodiments, a user may be given the option selecting a preferred price and schedule from a plurality of prices and schedules.

As depicted in block 312 of FIG. 3, the methods of the present invention further may comprise transmitting a price quote for the well service, the price quote comprising the price and schedule that were determined for the well service. In some embodiments, the price quote may be transmitted to the user as discussed above for the transmission of data from pricing and scheduling system 206 in relation to FIG. 2. Once transmitted to the user, the user may have the option of accepting the transmitted price quote, wherein the user may be prompted for a response, depicted in block 314. In some embodiments, the customer may be the user. In other embodiments, the user may be associated with a provider of well services, wherein the user may have to transmit the price quote to the customer. In some embodiments, more than one price quote may be transmitted to the user. In these embodiments, each price quote transmitted to the user may have a different schedule and a corresponding price for that schedule. For example, three price quotes may be transmitted to the user, wherein three different schedules, each having a corresponding price are transmitted to the user. In these embodiments, the user may accept a suitable price quote from the different price quotes that were transmitted.

If the customer does not accept the price quote that was transmitted thereto, in some embodiments, the user may have the option of performing the methodology again until an acceptable price and schedule are obtained, wherein the user may be prompted for a response, depicted in block 315. For example, in performing the methodology again, the user may modify, well characteristics, design specifications, design objectives, and/or customer scheduling preferences to obtain an acceptable price. In some embodiments, if the user desires to perform the methodology again, the execution of the methodology moves to block 302 for obtaining input data.

If the customer accepts the price quote that was transmitted thereto, in some embodiments, the methods of the present invention further may comprise completing a sale of the well service based on the price quote for the well service, depicted in block 316 of FIG. 3. In some embodiments, the sale may be completed by a data processing system, such as computer system 100 (depicted in FIG. 1). Completing the sale of the well service may be accomplished by utilizing any suitable technique for completing the sale of a well service between a customer and a provider of well services. In one embodiment, where the price quote was transmitted to a data processing system (such as user computer system 202 depicted on FIG. 2) over a wide area network, e.g., an Internet-based communication system, an online purchasing technique may be used. Any suitable online purchasing technique may be used, including, but not limited to, expedited online purchasing techniques, wherein required data for completing the purchase is saved so the purchasing technique does not include a step of submitting data. One of ordinary skill in the art, with the benefit of this disclosure, will be able to select an appropriate technique for completing the sale of the well service for a particular application.

If the sale is completed, in some embodiments, the methods of the present invention further may comprise, scheduling the well service, depicted in block 318. In some embodiments, the well service may be scheduled by a data processing system, such as computer system 100 (depicted in FIG. 1). Scheduling the well service may comprise placing the well service into the well service provider's process for scheduling well services. Once scheduled, resources to execute the well service may be mobilized, the well service may be executed, and post-job reporting may be performed.

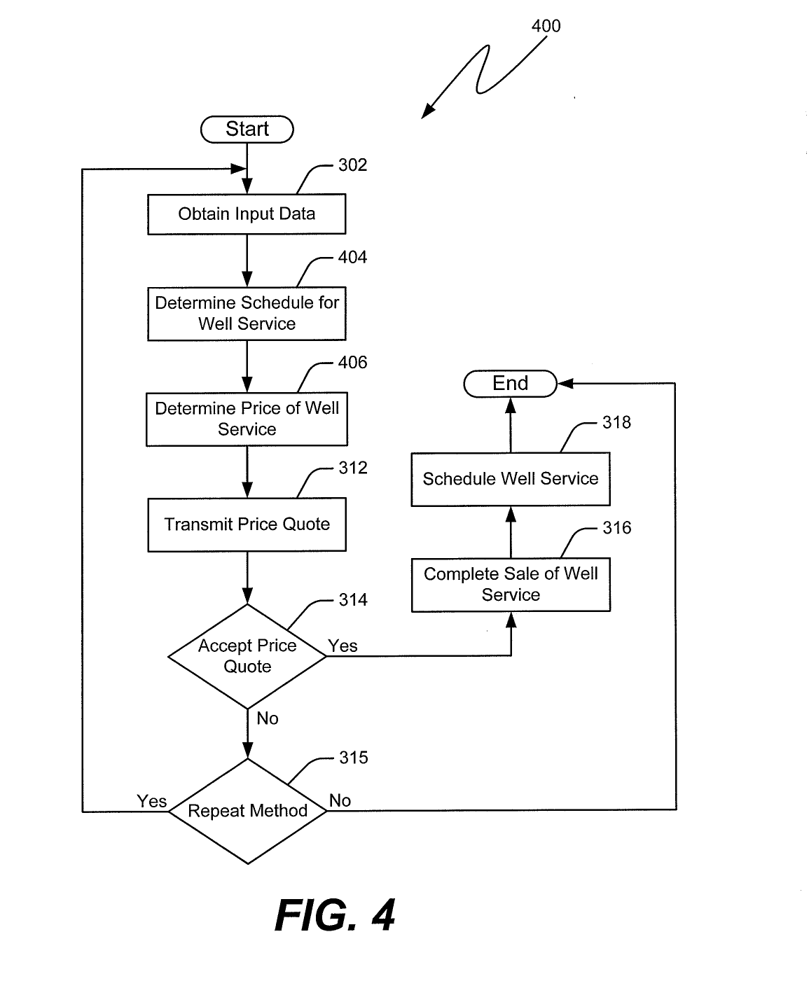

Referring to FIG. 4, a flow chart is illustrated that depicts an embodiment of a method of the present invention, generally referred to as method 400, that may be performed by scheduling and pricing system 206. In some embodiments, a data processing system (such as those illustrated in FIG. 1) may be used to implement this method. Method 400 generally involves determining a price and schedule for a well service in accordance with one embodiment of the present invention. Method 400 of the present invention generally comprises obtaining input data for the well service (block 302), the input data comprising well characteristics of well service; determining a schedule for the well service (block 404); determining a price of the well service based on a plurality of factors (block 406), the plurality of factors comprising the schedule for the well service and the well characteristics of the well service; transmitting a price quote for the well service to a user (block 312), the price quote comprising the schedule and the price that were determined; determining whether the transmitted price quote is accepted (block 314); completing a sale of the well service (block 316); and scheduling the well service, if the sale is completed (block 318). Those of ordinary skill in the art will appreciate that certain of the above-listed steps may be optional, depending upon the particular application.

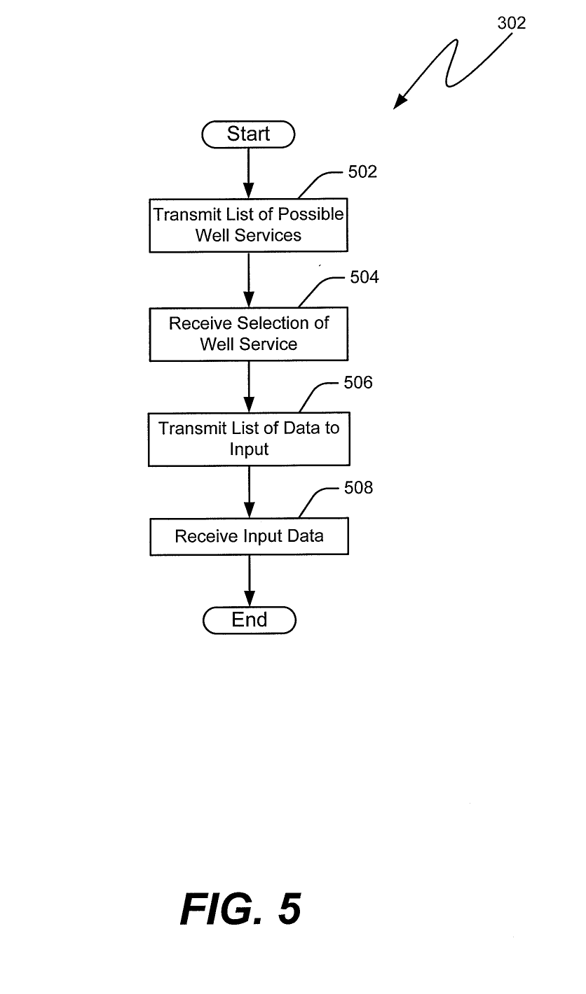

In block 302 of FIG. 4, input data for the well service is obtained. In some embodiments, the input data may be obtained using a data processing system, such as computer system 100 (depicted in FIG. 1). Input data may include, but is not limited to, well characteristics, design specifications, design objectives, and/or customer scheduling preferences. The input data may be obtained for a particular well or set of wells (e.g., wells in a particular field) dependent upon the particular well service. The particular input data and methods of obtaining the input are discussed above with respect to block 304 of FIG. 3 and with respect to FIG. 5 below.

In block 404 of FIG. 4, a schedule for the well service is determined. Generally, an optimal schedule may be determined based on any of a variety of factors, including, but not limited to, the design specifications, customer scheduling preferences, equipment utilization targets, inventory, availability of resources, and other scheduled well services. Regarding customer scheduling preferences, in some embodiments, the user may specify one or more dates for the well service. In some embodiments, the user may specify whether flexible scheduling is allowed. For example, some users may desire to have the well service performed on a specific date or dates, while other customers may not have a preference of the date the well service is performed. The schedule also may be based on utilization rates. Generally, well service companies prefer to maximize utilization rates of equipment so as to optimize the efficiency of equipment utilization. In some embodiments, more than one schedule for the well service may be determined. For example, more than one schedule may be determined where the user will be given the option of selecting a preferred price and schedule from a plurality of prices and schedules. The schedule may be determined using any of a variety of optimization algorithms, including, but not limited to, linear programming, integer programming, genetic algorithms, neural networks, simulation, simulated annealing and combinations thereof.

In block 406 of FIG. 4, a price for the well service is determined. In some embodiments, the price may be determined by a data processing system, such as computer system 100 (depicted in FIG. 1) capable of determining a price of the well service treatment based on the well characteristics and the schedule. Determining a price of the well service based on the well characteristics may be accomplished by any suitable methodology, taking into account, for example, known and/or determinable factors and weights associated with each of the one or more well characteristics. For example, historical data for a number of previous well services may be collected and analyzed. This historical data may include the well characteristics associated with the previous well services and the overall prices for the previous well services that include the cost of the chemicals, tools, and/or equipment utilized in the particular well service. Once this historical data is collected and analyzed, a relationship may be determined between the well characteristics from the previous well service and the overall price of the previous well service. In some embodiments, this relationship between the price of a well service and well characteristics may be expressed as a mathematical algorithm, wherein determining the price of the well service may include utilization of the mathematical algorithm. In other embodiments, this relationship may be used to develop a look-up table for each of the well characteristics. Determining the price of a well service based on well characteristics is described in more detail in U.S. patent application Ser. No. 10/929,285, the disclosure of which is incorporated herein by reference.

The price of the well service should also be based on the schedule for the well service determined in block 404. Where the price of the well service is based on the schedule, the availability of resources also may be considered in determining the price. Where the price of the well service is based on the schedule, inventory also may be considered in determining the price. Where the price of the well service is based on the schedule, other scheduled services also may be considered in determining the price. Other factors that may be considered in determining the price include, but are not limited to, profit margin targets, the identity of the customer (e.g., pricing arrangements), and flexible scheduling discounts. Where a flexible scheduling discount is considered, a discount may be applied to the price if the customer allows flexible scheduling.

In some embodiments, determining the price of the well service may comprise correlating the price of the well service with the schedule. For example, the price for the well service may be correlated with the schedule so that a schedule is determined that corresponds to the lowest price for the well service.

In some embodiments, more than one price for the well service is determined. For example, where more than one schedule was determined, a price may be determined corresponding to each schedule. In these embodiments, a user may be given the option selecting a preferred price and schedule from a plurality of prices and schedules.

The methods of the present invention further may comprise transmitting a price quote for the well service, the price quote comprising the price and the schedule that were determined for the well service, depicted in block 312 of FIG. 4. The price quote may be transmitted as discussed above with respect to FIG. 3. For example, the list of data to input may be transmitted to a user of user computer system 202 via one or more screens on a website. Once transmitted to the user, the user may have the option of accepting the transmitted price quote, wherein the user may be prompted for a response, depicted in block 314. In some embodiments, the customer may be the user. In other embodiments, the user may be associated with a provider of well services, wherein the user may have to transmit the price quote to the customer. In some embodiments, more than one price quote may be transmitted to the user. In these embodiments, each price quote transmitted to the user may have a different schedule and a corresponding price for that schedule. For example, three price quotes may be transmitted to the user, wherein three different schedules, each having a corresponding price are transmitted to the user. In these embodiments, the user may accept a suitable price quote from the different price quotes that were transmitted.

If the customer does not accept the price quote that was transmitted thereto, in some embodiments, a user may have the option of performing the methodology again, as depicted in block 315 of FIG. 4, until an acceptable price and schedule are obtained, wherein the user may be prompted for a response. For example, in performing the methodology again, the user may modify, well characteristics, customer scheduling preferences, and/or design objectives to obtain an acceptable price. In some embodiments, if the user desires to perform the methodology again, the execution of the methodology moves to block 302 for determining well input data.

If the customer accepts the price quote that was transmitted thereto, in some embodiments, the methods of the present invention further may comprise completing a sale of the well service based on the price quote for the well service, depicted in block 316 of FIG. 4. Completing the sale of the well service is described in more detail with respect to FIG. 3.

If the sale is completed, in some embodiments, the methods of the present invention further may comprise, scheduling the well service, as depicted in block 318 of FIG. 4. Scheduling the well service may comprise placing the well service into the well service provider's process for scheduling well services. Once scheduled, resources to execute the well service may be mobilized, the well service may be executed, and post-job reporting may be performed.

Referring now to FIG. 5, a flow chart is illustrated that depicts one embodiment of the present invention for obtaining input data for the well service, generally referenced by the number 302. The well input data may include, but is not limited to, customer information, customer scheduling preferences, well characteristics, design specifications, and/or design objectives, and/or. In one embodiment, obtaining input for a well service may comprise transmitting a list of possible well services to a user, depicted in block 502. In some embodiments, the list of possible well services may be transmitted to the user as discussed above for the transmission of data to user computer system 202 by pricing and scheduling system 206. For example, the list of possible well services may be transmitted to a user of user computer system 202 via one or more screens on a website. The list of well services may include any of a variety of well services that may be performed in oil, gas, geothermal, and/or water wells, such as drilling, completion, and workover operations. The drilling, completion, and workover operations may include, but are not limited to, drilling, fracturing, acidizing, logging, gravel packing, cementing, perforating, and conformance operations.

Obtaining the input data for the well service further may comprise receiving a selection of the well service to be priced and scheduled from the user based on the transmitted list of possible well services, depicted in block 504 of FIG. 5. In some embodiments, the selection of the well service may be obtained from the user as discussed above for the obtainment of data by pricing and scheduling system 206. For example, the selection may be obtained from a user of user computer system 202 via one or more screens on a website. Referring again to FIG. 5, once the selection of the well service is obtained, this embodiment further may comprise transmitting to the user a list of data (e.g., well characteristics, design specifications, design objectives, and/or customer scheduling preferences) to input based on the well service that was selected from the list, depicted in block 506. In some embodiments, the list of the data to input may be transmitted to the user as discussed above for the transmission of data by pricing and scheduling system 206. For example, the list of data to input may be transmitted to a user of user computer system 202 via one or more screens on a website. The list of the data to input may include a preselected list of well characteristics, design specifications, design objectives, and/or customer scheduling preferences suitable for generating a price and schedule based on selection of the particular well service that was obtained. Next, obtaining input data of the well service further may comprise receiving from the user the input data for the well service, depicted in block 508 of FIG. 5. In some embodiments, the input data may be obtained from the user as discussed above for the obtainment of data by pricing and scheduling system 206. For example, the input data may be obtained from a user of user computer system 202 via one or more screens on a website. The input data obtained from the user generally should be based on the transmitted list of the data to input.

In some embodiments, one or more steps of the above-described methods may be performed by a data processing system, such as computer system 100 (depicted in FIG. 1). For example, computer system 100 may be capable of performing one or more steps of the above-described methods.

Some embodiments of the present invention may comprise utilizing a neural network. For example, the neural network may be used to determine the one or more well characteristics. In some embodiments, where the methods of the present invention are implemented on a data processing system, the data processing system may comprise a neural network. U.S. Pat. No. 6,002,985, the entire disclosure of which is incorporate herein by reference, describes utilization of a neural network in conjunction with well services.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A method of pricing and scheduling one or more well services comprising:
using a data processing system to obtain input data for the one or more well services, wherein the input data comprises at least an input selected from the group consisting of a well characteristic, a design specification, a design objective, and any combinations thereof;
determining a specification for the one or more well services, wherein the specification is determined by the input data;
determining a schedule for the one or more well services;
determining a price of the one or more well services based on a plurality of factors, wherein the plurality of factors comprise the schedule and the well characteristic; and
providing a price quote and schedule for the one or more well services.

2. The method of claim 1, wherein the input data is obtained from a user of a computer system via one or more screens of a website.

3. The method of claim 1, wherein the schedule is determined based on at least one factor selected from the group consisting of a well service specification, a customer preference, an equipment utilization target, an inventory, an availability of a resource, another scheduled service, and any combinations thereof.

4. The method of claim 1, wherein the plurality of factors for determining the price further comprises at least one factor selected from the group consisting of an availability of a resource, an inventory, another scheduled service, a profit margin target, a customer's identity, a flexible scheduling discount, and any combinations thereof.

5. The method of claim 1, wherein the plurality of factors for determining the price further comprises other scheduled well services.

6. The method of claim 1, wherein determining the price comprises correlating the price with the schedule that was determined.

7. The method of claim 1, wherein more than one schedule is determined and a price is determined for each schedule.

8. A system for pricing and scheduling one or more well services comprising:
a processor; and
a memory communicatively coupled to the processor;
the processor configured for:
obtaining input data for the one or more well services, wherein the input data comprises at least an input selected from the group consisting of a well characteristic, a design specification, a design objective, and any combinations thereof;
determining a specification for the one or more well services, wherein the specification is determined by the input data;
determining a schedule for the one or more well services;
determining a price of the one or more well services based on a plurality of factors, wherein the plurality of factors comprise the schedule and the well characteristic; and
providing a price quote and schedule for the one or more well services.

9. The system of claim 8, wherein the processor is configured to obtain input data from a user of a computer system via one or more screens of a website.

10. The system of claim 8, wherein the processor is configured for:
transmitting a list of well services to a user;
receiving a selection of the one or more well services to be priced and scheduled;
transmitting to the user a list of data to be obtained; and
receiving from the user the input data for the well service.

11. The system of claim 8, wherein the processor is configured to consider other scheduled well services in determining the price.

12. The system of claim 8, wherein the processor is configured to correlate the price with the schedule when determining the price.

13. The system of claim 8, wherein the processor is configured to determine more than one schedule and to determine a price for each schedule.

14. The system of claim 8, wherein the processor is configured for transmitting one or more price quotes to a user, and each price quote comprising a schedule and a price.

15. The system of claim 8, wherein the processor is one central processing unit or is distributed across one or more processors in one or more locations.

16. A system for pricing and scheduling one or more well services comprising:
a processor; and
a memory communicatively coupled to the processor;
the processor configured for:
obtaining input data for the one or more well services, wherein the input data comprises well characteristics;
determining a specification for the one or more well services based on the input data;
determining a schedule for the one or more well services,
determining a price for the one or more well services based on a plurality of factors, wherein the plurality of factors comprise the schedule and the well characteristics; and
providing an output comprising a price quote and the schedule for the one or more well services.

17. The system of claim 16, wherein the processor is configured to consider other scheduled well services in determining the price.

18. The system of claim 16, wherein the processor is configured to correlate the price with the schedule when determining the price.

19. The system of claim 16, wherein the processor is configured to determine more than one schedule and to determine a price for each schedule.

20. A method of pricing and scheduling one or more well services comprising:
providing a data processing system;
using the data processing system to obtain input data for the one or more well services, wherein the input data comprises at least one datum selected from the group consisting of a well characteristic, a design specification, a design objective, and any combinations thereof;
using the data processing system to determine a specification for the one or more well services based on the input data;
using the data processing system to determine a schedule for the one or more well services;
using the data processing system to determine an internal cost for the one or more well services;
using the data processing system to determine a price for the one or more well services based on a plurality of factors, wherein the plurality of factors comprise the schedule and the internal cost; and
providing an output from the data processing system, the output comprising a price quote and the schedule for a sale of the one or more well services.

21. The method of claim 20, wherein the one or more well services are for a well or a set of wells.

22. The method of claim 20, wherein the input data comprises at least one input selected from the group consisting of customer information, customer scheduling preferences, well characteristics, design objectives, and any combinations thereof.

23. The method of claim 20, wherein the input data comprises an input that indicates whether flexible scheduling is allowed.

24. The method of claim 20, wherein the input data is obtained from a user of a computer system via one or more screens of a website.

25. The method of claim 20, wherein obtaining input data comprises the steps of:
transmitting a list of well services to a user;
receiving a selection of the one or more well services to be priced and scheduled;
transmitting to the user a list of data to be obtained; and
receiving from the user the input data for the well service.

26. The method of claim 20, wherein the schedule is determined based on at least one factor selected from the group consisting of a well service specification, a material and equipment requirement, a customer preference, an equipment utilization target, an inventory, an availability of a resource, another scheduled service, and any combinations thereof.

27. The method of claim 20, wherein the schedule is determined using at least one methodology selected from the group consisting of linear programming, integer programming, a genetic algorithm, a neural network, a simulation, simulated annealing, and any combinations thereof.

28. The method of claim 20, wherein the plurality of factors for determining the price further comprise at least one factor selected from the group consisting of the availability of resources, the inventory, other scheduled services, a profit margin target, customer identity, a flexible scheduling discount, and any combinations thereof.

29. The method of claim 20, wherein other scheduled well services are considered in determining the price.

30. The method of claim 20, wherein determining the price comprises correlating the price with the schedule that was determined.

31. The method of claim 20, wherein more than one schedule is determined and a price is determined for each schedule.

32. The method of claim 20, comprising the step of transmitting one or more prices quote to a user, each price quote comprising a schedule and a price.

33. The method of claim 32, comprising the steps of:
completing a sale of the one or more well services; and
scheduling the one or more well services.
